(19) United States
(12) Patent Application Publication
(10) Pub. No.: US 2026/0196512 A1
(43) Pub. Date: Jul. 9, 2026

(54) NEGATIVE ELECTRODE SLURRY AND METHOD OF PRODUCING THE SAME

(71) Applicant: Prime Planet Energy & Solutions, Inc., Tokyo (JP)

(72) Inventors: Shinya HIROSHIMA, Kobe-shi (JP); Tatsuya IKENUMA, Kobe-shi (JP)

(21) Appl. No.: 19/432,110

(22) Filed: Dec. 24, 2025

(30) Foreign Application Priority Data
Jan. 7, 2025 (JP) 2025-002292

(51) Int. Cl. H01M 4/62; H01M 4/02

(52) U.S. Cl. CPC H01M 4/622; H01M 2004/027

(57) ABSTRACT

A negative electrode slurry for a non-aqueous electrolyte secondary battery contains a negative electrode active material, a thickening polysaccharide, an alcohol having 5 or less carbon atoms, and water. A content of the alcohol is from 0.70 to 3.50 weight % of the negative electrode slurry.

### CROSS REFERENCE TO RELATED APPLICATIONS

This nonprovisional application is based on Japanese Patent Application No. JP2025-002292 filed on Jan. 7, 2025, with the Japan Patent Office, the entire contents of which are hereby incorporated by reference.

### BACKGROUND OF THE INVENTION

### Field of the Invention

The present invention relates to a negative electrode slurry and a method of producing the same.

### Description of the Background Art

It is known that a negative electrode of a secondary battery can be prepared by applying negative electrode slurry to a current collector. At the time of production, by accident, negative electrode slurry can become contaminated with bacteria (see Japanese Patent Laying-Open No. 2013-114959 and Japanese Patent No. 7548010, for example).

### SUMMARY OF THE INVENTION

Bacteria in negative electrode slurry can grow by feeding on thickening polysaccharides contained in the negative electrode slurry, and thereby cause viscosity degradation and/or decomposition of the negative electrode slurry. When the viscosity is degraded, applicability of the negative electrode slurry to a current collector is impaired.

For inhibiting bacterial growth, agents such as preservatives, antimicrobials, or bactericides can be added to negative electrode slurry. However, when the negative electrode slurry contains such agents, the viscosity of the negative electrode slurry can rise during storage and applicability to a current collector can be impaired.

The present disclosure aims at providing a negative electrode slurry having a suitable viscosity for application to a current collector, as well as a method of producing the same.
[1] A negative electrode slurry for a non-aqueous electrolyte secondary battery, comprising:
a negative electrode active material;
a thickening polysaccharide;
an alcohol having 5 or less carbon atoms; and
water, wherein
a content of the alcohol is from 0.70 to 3.50 weight % of the negative electrode slurry.
[2] The negative electrode slurry according to [1], wherein the number of colonies counted by a colony-counting procedure described below is 1.0×10⁵/mL or less, and
the colony-counting procedure involves diluting the negative electrode slurry 10000-fold to obtain a diluted liquid, inoculating the diluted liquid onto a film medium, and counting the number of colonies formed on the film medium after a lapse of 24 hours of incubation in a thermostatic chamber at 32° C.
[3] The negative electrode slurry according to [1] or [2], wherein the thickening polysaccharide includes a cellulose derivative.
[4] The negative electrode slurry according to [3], wherein the cellulose derivative is carboxymethylcellulose.
[5] The negative electrode slurry according to any one of [1] to [4], further comprising a binder.
[6] The negative electrode slurry according to [5], wherein the binder includes at least one of styrene-butadiene rubber and polyacrylic acid.
[7] The negative electrode slurry according to any one of [1] to [6], wherein the alcohol is ethanol.
[8] A method of producing a negative electrode slurry for a non-aqueous electrolyte secondary battery, the method comprising:
obtaining a kneaded product containing a negative electrode active material, a thickening polysaccharide, and water; and
adding an alcohol having 5 or less carbon atoms to the kneaded product and stirring, wherein
a content of the alcohol in the negative electrode slurry is from 0.70 to 3.50 weight % of the negative electrode slurry.
[9] The method of producing a negative electrode slurry according to [8], wherein
the obtaining a kneaded product involves kneading the negative electrode active material, the thickening polysaccharide, and water, then further adding a binder and water, and then kneading, and
the binder includes at least one of styrene-butadiene rubber and polyacrylic acid.

The method of producing a negative electrode slurry according to [8] or [9], wherein
the number of colonies counted by a colony-counting procedure described below is 1.0×10⁵/mL or less, and
the colony-counting procedure involves diluting the negative electrode slurry 10000-fold to obtain a diluted liquid, inoculating the diluted liquid onto a film medium, and counting the number of colonies formed on the film medium after a lapse of 24 hours of incubation in a thermostatic chamber at 32° C.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a flowchart illustrating the procedure to produce a negative electrode slurry according to an embodiment.

### DESCRIPTION OF THE PREFERRED EMBODIMENTS

Herein, a numerical range such as “from x to y” includes the upper limit and the lower limit, unless otherwise specified. That is, “(from) x to y” means a numerical range of “not less than x and not more than y”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

### <Negative Electrode Slurry>

A negative electrode slurry according to the present embodiment (hereinafter also called “the present slurry (1)”) can be used for forming a negative electrode active material layer of a negative electrode of a non-aqueous electrolyte secondary battery (hereinafter also called “a secondary battery”). The negative electrode can have a current collector, as well as a negative electrode active material layer formed on the current collector. The negative electrode active material layer can be formed by drying, compression, and the like of the present slurry (1) applied on the current collector. The secondary battery may be a lithium-ion secondary battery that is charged and discharged through occlusion and release of lithium ions.

The present slurry (1) contains a negative electrode active material, a thickening polysaccharide, an alcohol having 5 or less carbon atoms (hereinafter also called “a lower alcohol”), and water. The content of the lower alcohol in the present slurry (1), as expressed as a proportion by weight in the present slurry (1), is from 0.70 to 3.50 weight % of the present slurry (1).

It is conceivable that the present slurry (1) can become contaminated with bacteria during production of the present slurry (1). “During production of the present slurry (1)” means during such steps as preparation of the present slurry (1), transfer of the present slurry (1) through piping after preparation of the present slurry (1), and/or storage and the like of the present slurry (1) performed after preparation of the present slurry (1) and before application to the current collector. Because the present slurry (1) contains a lower alcohol at 0.70 weight % or more, bacterial growth in the present slurry (1) can be inhibited, and thereby degradation of the viscosity of the present slurry (1) during storage of the present slurry (1) can be inhibited. Because the content of a lower alcohol in the present slurry (1) is 3.50 weight % or less, a rise of the viscosity of the present slurry (1) during storage of the present slurry (1) can be inhibited. As a result, the present slurry (1) can have a suitable viscosity for application of the present slurry (1) to the current collector for preparation of a negative electrode, and degradation of applicability of the present slurry (1) can be inhibited.

The viscosity of the present slurry (1) at the time when it is prepared by mixing a negative electrode active material, a thickening polysaccharide, a lower alcohol, and water is from 8 to 20 Pas, for example, and it may be from 9 to 18 Pa·s, or from 10 to 16 Pa·s, or from 11 to 18 Pa·s. Herein, the viscosity of the negative electrode slurry refers to a value on a flow curve obtained by measurement with a rheometer at 25° C., specifically a value at a shear rate of 0.1 s⁻¹.

The viscosity (measured at a temperature of 25° C.) of the present slurry (1) after the present slurry (1) is prepared and then left to stand for storage at 25° C. for 7 days is from 8 to 23 Pa·s, for example, and it may be from 10 to 20 Pa·s, or from 12 to 18 Pa·s, or from 15 to 20 Pa·s.

The solid content of the present slurry (1) is from 40 to 60 weight %, for example, and it may be from 43 to 59 weight %, or from 47 to 58 weight %, or from 51 to 57 weight %.

The negative electrode active material can include at least one of a carbon-based active material and a metal-based active material, for example, and it may include both a carbon-based active material and a metal-based active material. The carbon-based active material may be one, two, or more of carbon materials selected from the group consisting of graphite such as natural graphite and artificial graphite, hard carbon, soft carbon, and amorphous-coated graphite. The metal-based active material may be an elemental metal or a metal oxide including an element selected from the group consisting of silicon (Si), tin (Sn), antimony (Sb), bismuth (Bi), titanium (Ti), and germanium (Ge). Preferably, the metal-based active material is a Si-containing active material that contains silicon (Si). Preferably, the Si-containing active material includes one, two, or more selected from the group consisting of Si, SiOx (x=0.5 to 1.5), and SiC, and more preferably, it includes SiC or it is SiC. Preferably, SiOx is SiO.

Preferably, the negative electrode active material includes a carbon-based active material or it is a carbon-based active material; more preferably, it includes graphite or it is graphite; further preferably, it includes natural graphite or it is natural graphite.

When the negative electrode active material includes a carbon-based active material, the content of the carbon-based active material in the negative electrode active material is preferably 90 mass % or more, and it may be 92 mass % or more, or may be 95 mass % or more, or may be from 90 to 99 mass %, or may be from 92 to 98 mass %, or may be from 95 to 97 mass %.

Examples of the thickening polysaccharide include cellulose derivatives, xanthan gum, welan gum, gellan gum, guar gum, carrageenan, dextrin, alpha starch, pectic acid, alginic acid, and the like. Examples of the cellulose derivatives include carboxymethylcellulose (hereinafter also called “CMC”), methylcellulose, hydroxyethylcellulose, hydroxypropylcellulose, and the like. A thickening polysaccharide that can exist as a salt or an acid may be in salt form or acid form. The salt may be a salt of an alkali metal such as lithium and sodium, an ammonium salt, and the like. The thickening polysaccharide can include one, two, or more of the above-mentioned compounds.

Preferably, the thickening polysaccharide includes a cellulose derivative or it is a cellulose derivative; more preferably, it includes CMC or it is CMC. The CMC is preferably in salt form, more preferably an alkali metal salt, and, for example, it is a sodium salt.

The content of the thickening polysaccharide in the present slurry (1) is not particularly limited as long as it is selected so as to be suitable for the viscosity of the present slurry (1); for example, it is from 0.1 to 2.0 weight % of the total amount of the negative electrode active material, and it may be from 0.2 to 1.5 weight %, or from 0.3 to 1.0 weight %, or from 0.4 to 0.8 weight %. When the present slurry (1) contains two or more types of thickening polysaccharides, the content of the thickening polysaccharide is the total amount of these two or more types of thickening polysaccharides.

The purpose of adding the lower alcohol to the present slurry (1) is for inhibiting bacterial growth. The lower alcohol is not particularly limited as long as it is an alcohol having 5 or less carbon atoms. The number of carbon atoms in the lower alcohol may be 4 or less, or 3 or less, or 2 or less, or from 2 to 5, or from 2 to 4, or 2 or 3. The lower alcohol can include one, two, or more selected from the group consisting of methanol, ethanol, 1-propanol, 2-propanol, n-butyl alcohol, isobutyl alcohol, sec-butyl alcohol, and tert-butyl alcohol. Preferably, the lower alcohol includes ethanol or it is ethanol.

The content of the lower alcohol in the present slurry (1) relative to the total amount of the present slurry (1) is not particularly limited as long as it is from 0.70 to 3.50 weight %, and it may be from 0.80 to 3.20 weight %, or from 0.90 to 3.00 weight %, or from 0.95 to 2.50 weight %, or from 1.00 to 2.20 weight %, or from 1.10 to 2.00 weight %; preferably, it is from 0.99 to 1.96 weight %, more preferably from 1.08 to 1.48 weight %. When the present slurry (1) contains two or more types of lower alcohols, the content of the lower alcohol is the total amount of these two or more types of lower alcohols.

When the content of the lower alcohol is low, bacterial growth in the negative electrode slurry tends not to be inhibited. When the content of the lower alcohol is too high, the viscosity of the negative electrode slurry tends to rise during storage. It is conjectured that the rise of viscosity occurs due to changes in the state of dispersion of the thickening polysaccharide in the negative electrode slurry that tend to take place when the content of the lower alcohol in the negative electrode slurry is high. When the content of the lower alcohol is too high, due to the high viscosity of the negative electrode slurry, not enough amount of the negative electrode slurry is ejected at the time of application and thereby negative electrode productivity tends to be low.

The water is preferably pure water. Examples of pure water include distilled water, ion-exchanged water, water produced through a reverse osmosis membrane (RO water), purified water, and the like.

The number of colonies counted by “Colony-counting procedure” described below with the use of the present slurry (1) is preferably 1.0×10⁵/mL or less, more preferably 5.0×10⁴/mL or less, and it may be 4.0×10⁴/mL or less, or 2.0×10⁴/mL or less, or 1.0×10⁴/mL or less; and further preferably, it is less than 1.0×104/mL.

### (Colony-Counting Procedure)

The present slurry (1) is diluted 10000-fold to obtain a diluted liquid, the diluted liquid is inoculated onto a film medium, and after a lapse of 24 hours of incubation in a thermostatic chamber at 32° C., the number of colonies formed on the film medium is counted.

Although the colony-counting procedure is described above, the counting procedure is described in more detail in Examples. The present slurry (1) to be inoculated onto the film medium is the slurry immediately before application to the current collector, and for example, in a case where the prepared present slurry (1) is transferred through piping and/or stored, the slurry after these steps is innoculated. With the number of colonies falling within the above-mentioned range, degradation of the viscosity of the present slurry (1) due to bacterial growth during storage of the present slurry (1) can be inhibited. It is conceivable that a negative electrode slurry that can form many colonies on the film medium tends to undergo viscosity degradation during storage.

The type of bacteria contained in the colonies is not particularly limited, and examples thereof include bacteria belonging to one, two, or more genera selected from the group consisting of the genus Celluomonas, the genus Chryseobacterium, and the genus Bacillus. The bacteria contained in the colonies may include bacteria of the genus Celluomonas. Bacteria of the genus Celluomonas tend to cause degradation of the viscosity of the negative electrode slurry. When the number of colonies containing bacteria of the genus Celluomonas in the present slurry (1) falls within the above-mentioned range, viscosity degradation during storage can be inhibited.

The present slurry (1) can further contain at least one of a binder and a conductive material in addition to the negative electrode active material, the thickening polysaccharide, the lower alcohol, and water, and it may contain both of them.

Preferably, the present slurry (1) contains a binder. The binder herein refers to a binder except thickening polysaccharides. Examples of the binder include polyacrylic acid (hereinafter also called “PAA”), styrene-butadiene rubber (hereinafter also called “SBR”); polyvinyl alcohol; polyvinyl acetate; fluorine-containing resins such as polytetrafluoroethylene (PTFE) and polyvinylidene difluoride (PVdF); olefin-based resins such as polyethylene, polypropylene, ethylene-propylene-isoprene copolymer, and ethylene-propylene-butadiene copolymer; acrylonitrile butadiene rubber (NBR); polyacrylonitrile (PAN); polyimide; polyamide; acrylic resins such as ethylene-(acrylic acid) copolymer; and the like. The PAA may be in acid form, or it may be in salt form. The salt may be a salt of an alkali metal such as lithium and sodium, an ammonium salt, and the like. The present slurry (1) may contain one, two, or more of the above-mentioned binders.

The present slurry (1) preferably contains at least one of SBR and PAA, and more preferably, it contains SBR.

The content of the binder in the present slurry (1) is not particularly limited; for example, it is from 0.5 to 2.5 weight % of the total amount of the negative electrode active material, and it may be from 0.7 to 2.0 weight %, or from 1.0 to 1.5 weight %.

Examples of the conductive material include carbon materials such as fibrous carbon, carbon black (such as acetylene black and Ketjenblack), coke, activated carbon, and the like. Examples of the fibrous carbon include carbon nanotubes (hereinafter also called “CNTs”). The CNTs may be single-walled carbon nanotubes (SWCNTs), or may be multi-walled carbon nanotubes such as double-walled carbon nanotubes (DWCNTs). The present slurry (1) may contain one, two, or more of the above-mentioned conductive materials.

### <Method of Producing Negative Electrode Slurry>

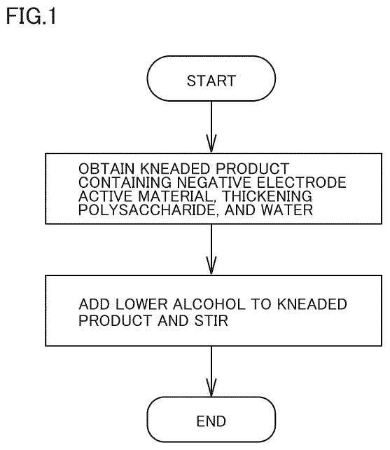

FIG. 1 is a flowchart illustrating the procedure to produce a negative electrode slurry according to an embodiment. The method of producing a negative electrode slurry (hereinafter also called “the present method”) is a method of producing a negative electrode slurry for a secondary battery (a non-aqueous electrolyte secondary battery). A negative electrode slurry produced by the present method (hereinafter also called “the present slurry (2)”) can be used for forming a negative electrode active material layer of a negative electrode of a secondary battery. The present slurry (2) may be the present slurry (1) described above, or may be a negative electrode slurry other than the present slurry (1).

The present method includes obtaining a kneaded product containing a negative electrode active material, a thickening polysaccharide, and water (hereinafter also called “a step to obtain a kneaded product”), as well as adding an alcohol having 5 or less carbon atoms (a lower alcohol) to the kneaded product and stirring (hereinafter also called “a stirring step”). The content of the lower alcohol in the present slurry (2), as expressed as a proportion by weight in the present slurry (2), is from 0.70 to 3.50 weight % of the present slurry (2).

According to the present method, in the step to obtain a kneaded product, a kneaded product containing a negative electrode active material, a thickening polysaccharide, and water and not containing a lower alcohol is obtained, and in the stirring step, a lower alcohol is added to the kneaded product and the resultant is stirred. In this case, during the step to obtain a kneaded product, a kneaded product in which the negative electrode active material and the thickening polysaccharide are uniformly dispersed tends to be obtained, and thereby the present slurry (2) in which the negative electrode active material and the thickening polysaccharide are well dispersed tends to be obtained. On the other hand, if a lower alcohol is added at the time of kneading the negative electrode active material and the thickening polysaccharide, a kneaded product in which the negative electrode active material and the thickening polysaccharide are uniformly dispersed tends not to be obtained, and the negative electrode active material and the thickening polysaccharide tend not to be uniformly dispersed in the negative electrode slurry.

According to the present method, the content of the lower alcohol in the present slurry (2) falls within the above-mentioned range, and therefore, during storage of the present slurry (2), degradation of the viscosity of the negative electrode slurry due to bacterial growth as well as a rise of the viscosity of the negative electrode slurry due to the lower alcohol can be inhibited. Thus, applicability of the present slurry (2) to a current collector can be good.

The kneaded product may contain at least one of a binder and a conductive material in addition to the negative electrode active material, the thickening polysaccharide, and water.

The step to obtain a kneaded product may include a step to knead the negative electrode active material, the thickening polysaccharide, and water. This step is a step to knead the negative electrode active material, the thickening polysaccharide, and water without adding a lower alcohol. This kneading step may include, for example:
a step (a) to mix powders of the negative electrode active material and the thickening polysaccharide;
a step (b) to add water to the mixture obtained in the step (a) and knead; and
a step (c) to add water to a kneaded product (b) obtained in the step (b) for dilution, and then add a binder and knead.

The kneaded product obtained in the step to obtain a kneaded product may be the kneaded product (b), or may be a kneaded product (c) obtained in the step (c). The conductive material can be added in at least one of the step (a) and the step (b).

The kneading step and the stirring step can be implemented with the use of a known kneading apparatus. Examples of the kneading apparatus include a stirrer equipped with a rotating blade, a filmixer, a media agitation mill, a planetary mixer, a twin-screw kneader, and the like.

In the present method, as the negative electrode active material, the thickening polysaccharide, the lower alcohol, the water, the binder, and the conductive material, those described for the present slurry (1) can be used, respectively.

The number of colonies counted with the use of the present slurry (2) by the above-mentioned colony-counting procedure may fall within the range described for the present slurry (1). With the number of colonies falling within the above-mentioned range, viscosity degradation of the present slurry (2) due to bacterial growth during storage of the present slurry (2) can be inhibited.

### EXAMPLES

In the following, the present disclosure will be described in further detail by way of Examples and Comparative Examples.

### Comparative Example 1

Natural graphite as a negative electrode active material, CMC sodium salt as a thickening polysaccharide, SBR as a binder, and pure water as water were prepared. Powders of the negative electrode active material and the thickening polysaccharide were mixed to form a mixture. Water was added to the mixture, and the resultant was kneaded to form a kneaded product (b). Water was added to the kneaded product (b) for dilution, and then a binder was added thereto and stirred to form a kneaded product (c). The kneaded product (c) was defoamed and passed through a sieve, and thereby a negative electrode slurry was obtained. The composition ratio of the components in the negative electrode slurry was (negative electrode active material): (thickening polysaccharide): binder=98.3:0.5:1.2.

### Examples 1 to 4, Comparative Example 2

As a lower alcohol, ethanol was prepared. By the procedure described in Comparative Example 1, a kneaded product (c) was obtained. A lower alcohol was added to the kneaded product (c) and stirred, followed by defoaming and passing through a sieve to form a negative electrode slurry. The amount of the lower alcohol added here was adjusted so that the content became as specified in Table 1. The content of the lower alcohol specified in Table 1 is the content of the lower alcohol in the negative electrode slurry.

### [Counting Colonies]

With pure water containing bacteria at 10 CFU/mL or less, the negative electrode slurry obtained in the above manner was 10000-fold diluted, and thereby a diluted liquid was obtained. The diluted liquid in an amount of 1 mL was inoculated onto an easy-and-simple film medium (Petrifilm AC Plate (Aerobic Count) manufactured by 3M), and left in a thermostatic chamber at 32° C. for 24 hours. Then, the number of colonies formed on the easy-and-simple film medium was counted. Results are given in Table 1.

As for Comparative Example 1 and Example 1, on the easy-and-simple film medium on which the negative electrode slurry was inoculated, bacteria of the genera Celluomonas and Chryseobacterium were observed. As for Examples 2 to 4 and Comparative Example 2, the type of bacteria present on the easy-and-simple film medium on which the negative electrode slurry was inoculated was not identified.

### [Measurement of Viscosity of Negative Electrode Slurry]

(Measurement of Viscosity when Prepared)

The viscosity of the negative electrode slurry obtained in the above-described manner was measured at 25° C. with a rheometer. The value at a shear rate of 0.1 s⁻¹ on a flow curve obtained by the measurement was regarded as the viscosity of the negative electrode slurry when prepared. Results are given in Table 1, in the section “Viscosity when prepared”.

(Measurement of Viscosity after Left and Stored)

The negative electrode slurry prepared in the above-described manner was placed in a storage container, and left to stand and stored at 25° C. for 7 days. The viscosity of the negative electrode slurry after storage was measured by the procedure described above in the section “Measurement of Viscosity when Prepared”. Results are given in Table 1, in the section “Viscosity after left and stored”.

(Measurement of Viscosity after Stirring)

After left and stored, the negative electrode slurry was stirred. The viscosity of the negative electrode slurry after stirring was measured by the procedure described above in the section “Measurement of Viscosity when Prepared”. Results are given in Table 1, in the section “Viscosity after stirring”.

TABLE 1

| | Comp. | | | | | Comp. |
|---|---|---|---|---|---|---|
| | Ex. 1 | Ex. 1 | Ex. 2 | Ex. 3 | Ex. 4 | Ex. 2 |
| Lower alcohol | | | | | | |
| Content [wt %] | 0 | 0.99 | 1.38 | 1.96 | 2.91 | 4.76 |
| Number of colonies [×10⁴/mL] | 100.0 | 4.0 | <1.0 | <1.0 | <1.0 | <1.0 |
| Negative electrode slurry | | | | | | |
| Viscosity when prepared [Pa · s] | 16.40 | 14.66 | 15.72 | 11.50 | 17.14 | 15.81 |
| Viscosity after left and stored [Pa · s] | 1.79 | 8.78 | 17.43 | 15.66 | 21.56 | 27.56 |
| Viscosity after stirring [Pa · s] | 1.74 | 8.39 | 12.21 | 10.58 | 13.85 | 15.24 |

Results given in Table 1 indicate that in Examples 1 to 4, during storage of the negative electrode slurry, bacterial growth was inhibited and degradation of the viscosity of the negative electrode slurry was inhibited, and in addition, a rise of the viscosity of the negative electrode slurry was also inhibited.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A negative electrode slurry for a non-aqueous electrolyte secondary battery, comprising:
a negative electrode active material;
a thickening polysaccharide;
an alcohol having 5 or less carbon atoms; and
water, wherein
a content of the alcohol is from 0.70 to 3.50 weight % of the negative electrode slurry.

2. The negative electrode slurry according to claim 1, wherein the number of colonies counted by a colony-counting procedure described below is 1.0×10⁵/mL or less, and
the colony-counting procedure involves diluting the negative electrode slurry 10000-fold to obtain a diluted liquid, inoculating the diluted liquid onto a film medium, and counting the number of colonies formed on the film medium after a lapse of 24 hours of incubation in a thermostatic chamber at 32° C.

3. The negative electrode slurry according to claim 1, wherein the thickening polysaccharide includes a cellulose derivative.

4. The negative electrode slurry according to claim 3, wherein the cellulose derivative is carboxymethylcellulose.

5. The negative electrode slurry according to claim 1, further comprising a binder.

6. The negative electrode slurry according to claim 5, wherein the binder includes at least one of styrene-butadiene rubber and polyacrylic acid.

7. The negative electrode slurry according to claim 1, wherein the alcohol is ethanol.

8. A method of producing a negative electrode slurry for a non-aqueous electrolyte secondary battery, the method comprising:
obtaining a kneaded product containing a negative electrode active material, a thickening polysaccharide, and water; and
adding an alcohol having 5 or less carbon atoms to the kneaded product and stirring, wherein
a content of the alcohol in the negative electrode slurry is from 0.70 to 3.50 weight % of the negative electrode slurry.

9. The method of producing a negative electrode slurry according to claim 8, wherein
the obtaining a kneaded product involves kneading the negative electrode active material, the thickening polysaccharide, and water, then further adding a binder and water, and then kneading, and
the binder includes at least one of styrene-butadiene rubber and polyacrylic acid.

10. The method of producing a negative electrode slurry according to claim 8, wherein
the number of colonies counted by a colony-counting procedure described below is 1.0×10⁵/mL or less, and
the colony-counting procedure involves diluting the negative electrode slurry 10000-fold to obtain a diluted liquid, inoculating the diluted liquid onto a film medium, and counting the number of colonies formed on the film medium after a lapse of 24 hours of incubation in a thermostatic chamber at 32° C.
